(19) United States
(12) Patent Application Publication
(10) Pub. No.: US 2020/0003961 A1
(43) Pub. Date: Jan. 2, 2020

(54) PIN REMOVAL DEVICE FOR A FIBER OPTIC CONNECTOR, AND A COMBINATION OF PIN REMOVAL DEVICE AND FIBER OPTIC

(71) Applicants: Gloriole Electropic Technology Corp., Kaohsiung City (TW); Shen Zhen Wonderwin Technology Co., LTD., Shenzhen City (CN)

(72) Inventors: Ming-Hua CHANG, Kaohsiung City (TW); Yen-Chang LEE, Kaohsiung City (TW)

(21) Appl. No.: 16/204,412

(22) Filed: Nov. 29, 2018

(30) Foreign Application Priority Data
Jun. 27, 2018 (TW) 107208607

(51) Int. Cl. G02B 6/38

(52) U.S. Cl. CPC G02B 6/3831

(57) ABSTRACT

For a fiber optic connector including a casing sleeve receiving a ferrule with guide pins, a pin removal device includes a housing unit, a releasing unit and a removal member. The housing unit includes a receiving space to receive the guide pins. The releasing unit is to operate the pin retainer such that the pin retainer disengages from the guide pins, and is extendable through the housing unit into the casing sleeve. The removal member is inserted into the receiving space to clamp the guide pins and is movable relative to the housing unit to pull the guide pins and release the same from the pin retainer when the releasing unit operates the pin retainer to disengage from the guide pins.

### CROSS-REFERENCE TO RELATED APPLICATION

This application claims priority of Taiwanese Utility Model Patent Application No. 107208607, filed on Jun. 27, 2018.

### FIELD

The disclosure relates to a pin removal device, and more particularly to a pin removal device for a fiber optic connector.

### BACKGROUND

As shown in FIG. 1, a fiber optic connector 1 includes a casing sleeve 11, a ferrule 12 connected to the casing sleeve 11, and two guide pins 13 extending through the ferrule 12. When the guide pins 13 need to be replaced, a plier or a tool alike must be used to pull and remove the guide pins 13 from the ferrule 12. However, removal of the guide pins 13 in that way consumes time and labor because pulling the guide pins 13 requires manual labor to precisely align the tool with guide pins 13 and because it is difficult to manage the magnitude of forces needed to pull the guide pins 13. In addition, during a large force pulling operation, if the user loses the plier, or if the plier fails to bite the guide pins firmly, the guide pins can suddenly escape from the plier, fly outward and fall apart.

### SUMMARY

Therefore, an object of the disclosure is to provide a pin removal device that is suitable for a fiber optic connector and that can alleviate at least one of the drawbacks of the prior art.

According to one object of the disclosure, a pin removal device is provided for a fiber optic connector, which includes a casing sleeve surrounding a ferrule, guide pins protruding from a front face of the ferrule, and a pin retainer engaging the guide pins inside the casing sleeve for retention of the guide pins. The pin removal device includes a housing unit, a releasing unit and a removal member.

The housing unit is configured to be removably disposed around the casing sleeve, the front face of the ferrule and the guide pins. The housing unit includes a receiving space configured to receive the guide pins and the front face of the ferrule.

The releasing unit is configured to operate the pin retainer such that the pin retainer disengages from the guide pins, and is insertable into the housing unit and the casing sleeve.

The removal member is movably inserted into the receiving space in front of the ferrule. The removal member is configured to clamp the guide pins and movable forwardly relative to the housing unit to pull the guide pins and release the same from the pin retainer when the releasing unit is inserted into the housing unit and the casing sleeve and operates the pin retainer to disengage from the guide pins.

According to another object of the disclosure, a combination includes a fiber optic connector and a pin removal device.

The fiber optic connector includes a casing sleeve surrounding a ferrule, guide pins protruding from a front face of the ferrule, and a pin retainer engaging the guide pins inside the casing sleeve for retention of the guide pins.

The pin removal device includes a housing unit, a releasing unit and a housing unit, a releasing unit and a removal member.

The housing unit is removably disposed around the casing sleeve, the front face of the ferrule and the guide pins. The housing unit includes a receiving space configured to receive the guide pins and the front face of the ferrule.

The releasing unit is configured to operate the pin retainer such that the pin retainer disengages from the guide pins. The releasing unit is insertable into the housing unit and the casing sleeve.

The removal member is movably inserted into the receiving space in front of the ferrule. The removal member is configured to clamp the guide pins and movable forwardly relative to the housing unit to pull the guide pins and release the same from the pin retainer when the releasing unit is inserted into the housing unit and the casing sleeve and operates the pin retainer to disengage from the guide pins.

The pin retainer has a bridge portion fixed to the casing sleeve, and two holding portions connected to the bridge portion and holding respectively the guide pins. Each of the guide pins has an engagement groove engaging one of the holding portions.

### BRIEF DESCRIPTION OF THE DRAWINGS

Other features and advantages of the disclosure will become apparent in the following detailed description of the embodiments with reference to the accompanying drawings, of which:

FIG. 1 is a perspective view of a conventional fiber optic connector;

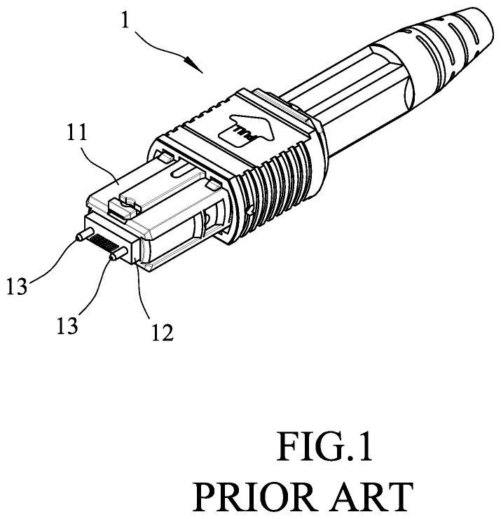

FIG. 2 is a perspective view of an embodiment of a combination according to the disclosure;

FIG. 3 is an exploded perspective view illustrating an outer housing, a removal member, an inner sleeve member, press rods, springs and a fiber optic connector of the embodiment;

FIG. 4 is a perspective view illustrating guide pins and a pin retainer of the embodiment;

FIG. 5 is a top section view of the embodiment;

FIG. 6 is side sectional view of the embodiment illustrating the guide pins being unclamped;

FIG. 7 is view similar to FIG. 6, but illustrating the guide pins being clamped; and

FIG. 8 is an exploded perspective view illustrating another configuration of the press rods of the disclosure.

### DETAILED DESCRIPTION

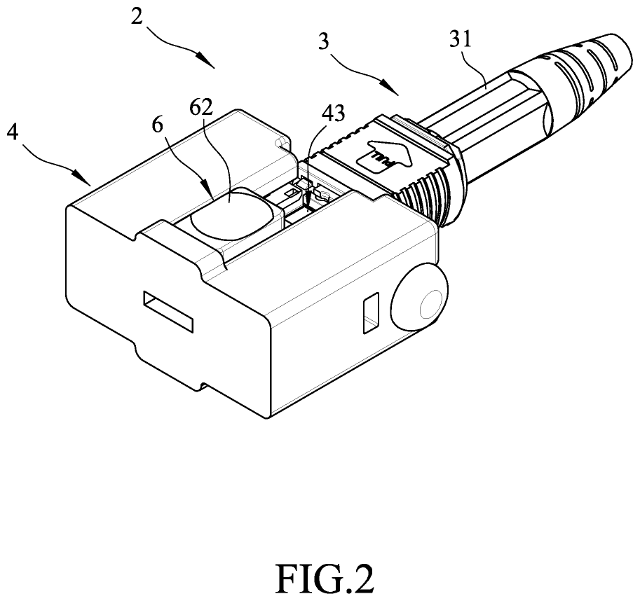

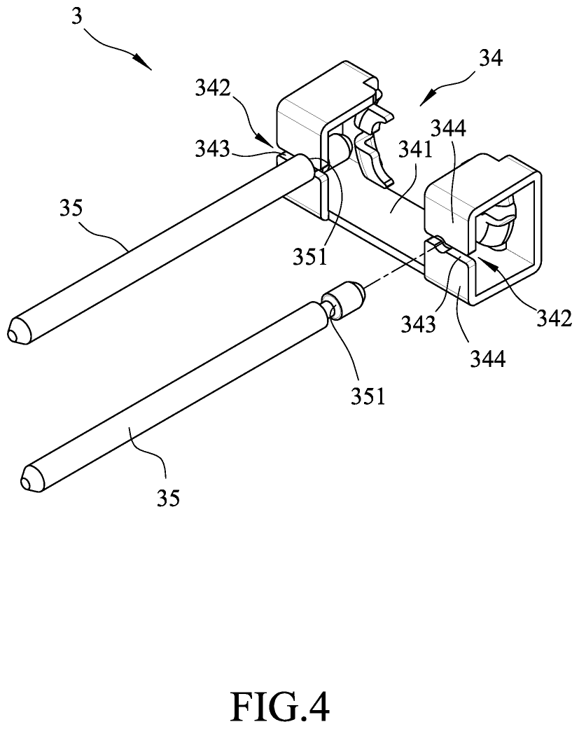

FIGS. 2 to 4 illustrate an embodiment of a pin removal device 2 according to the disclosure for a fiber optic connector 3. The fiber optic connector 3 includes a cable boot 31, a casing sleeve 32, a ferrule 33, guide pins 35 and a pin retainer 34. The casing sleeve 32 is connected to the cable boot 31 and surrounds the ferrule 33. The guide pins 35 protrude from a front face of the ferrule 33. The pin retainer 34 engages the guide pins 35 inside the casing sleeve 32 for retention of the guide pins 35.

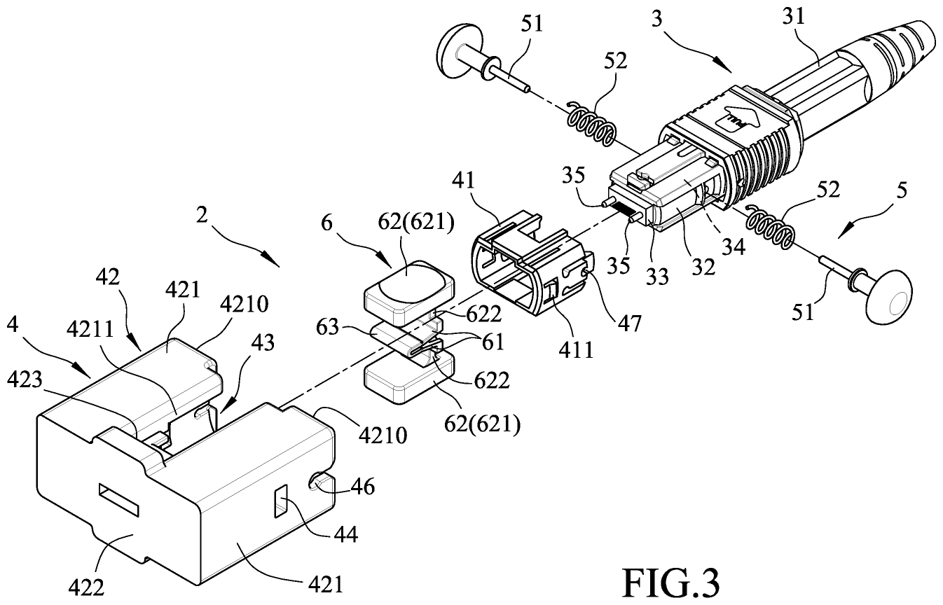

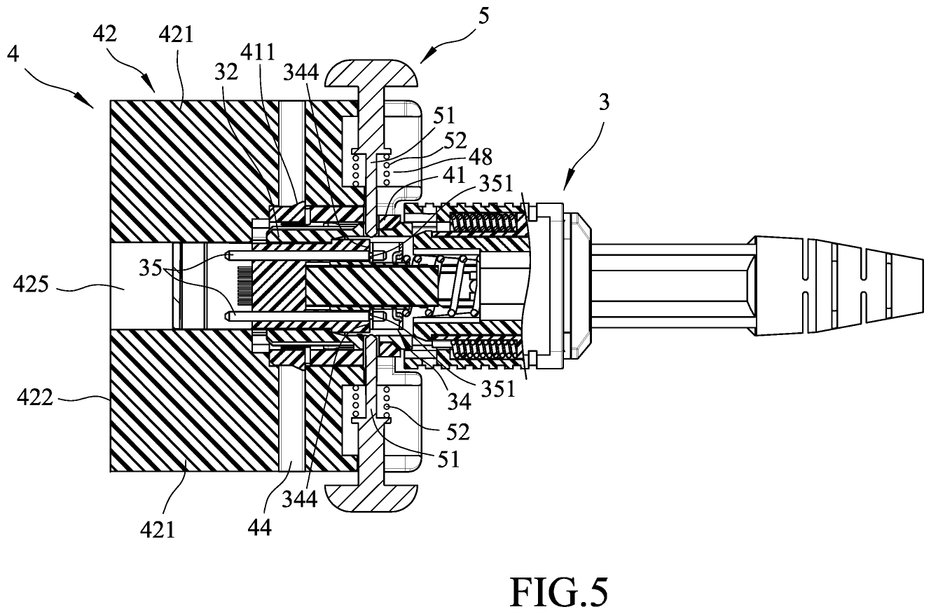

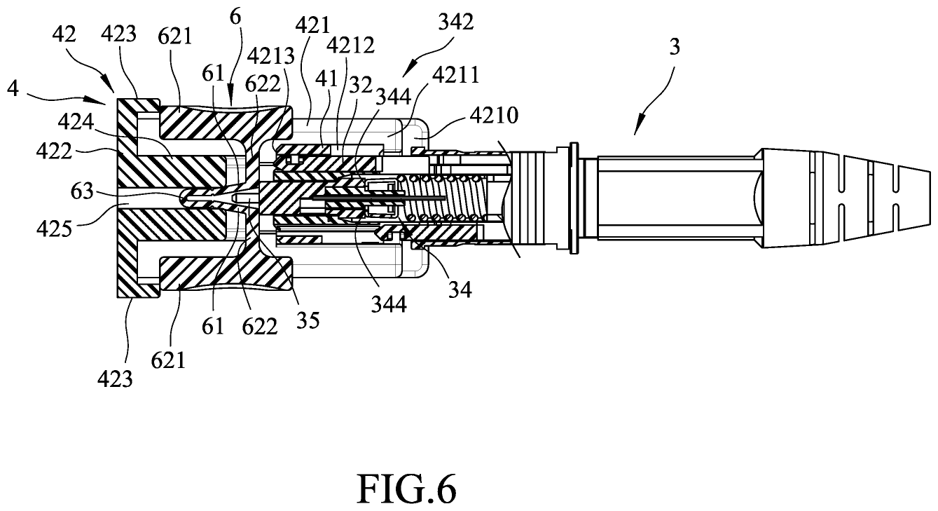

The pin retainer 34 is made of a shape recoverable material, such as a resilient metal material. In this embodiment, the pin retainer 34 has a bridge portion 341 fixed to the casing sleeve 32, and two spaced-apart holding portions 342 connected to the bridge portion 341 and respectively holding the guide pins 35. Each holding portion 342 has two clip arms 344 and a clearance 343 formed between the clip arms 344. Each guide pin 35 has a peripheral surface and an engagement groove 351 indented radially and inwardly from the peripheral surface. The clip arms 344 of each holding portion 342 extend into the engagement groove 351 of a corresponding one of the guide pins 35. Referring to FIGS. 5 and 6, in combination with FIG. 3, the pin removal device 2 includes a housing unit 4, a releasing unit 5 and a removal member 6.

The housing unit 4 is removably disposed around the casing sleeve 32, the front face of the ferrule 33 and the guide pins 35. The housing unit 4 includes an inner sleeve member 41 sleeves around the casing sleeve 32 rearwardly of the removal member 6 (details thereof will be described later), and an outer housing 42 receiving the inner sleeve member 41 and having a receiving space 43. The receiving space 43 receives the guide pins 35 and the front face of the ferrule 33. In this embodiment, the outer housing 42 further includes a front wall portion 422, two spaced-apart lateral portions 421, upper and lower abutment members 423 and a clamping plate mount 424. The lateral portions 421 extend rearwardly from the front wall portion 422 and define the receiving space 43 therebetween. The lateral portions 421 respectively have inner surfaces 4211 that border the receiving space 43, and retaining grooves 4212 that are respectively indented from the inner surfaces 4211 proximal to rear ends 4210 of the lateral portions 421. The receiving space 43 opens at the rear ends 4210 of the lateral portions 421. Each lateral portion 421 further has a shoulder face 4213 bounding one of the retaining grooves 4212. The upper and lower abutment members 423 respectively and rearwardly protrude from top and bottom ends of the front wall portion 422. The clamping plate mount 424 protrudes rearwardly from the front wall portion 422 and between the lateral portions 421, and has a mounting hole 425. The outer housing 42 has a U-shaped form.

The releasing unit 5 is insertable into the housing unit 4 and the casing sleeve 32, and is configured to operate the pin retainer 34 such that the pin retainer 34 disengages from the guide pins 35. The releasing unit 5 includes two press rods 51 and two springs 52. The press rods 51 respectively extend through the lateral portions 421 and are insertable into the inner sleeve member 41 and the casing sleeve 32 along two opposite inward directions transverse to the guide pins 35, and are operable to force the pin retainer 34 to disengage from the guide pins 35. The springs 52 are respectively sleeved on the press rods 51. In this embodiment, the press rods 51 are extendable into the clearances 343 of the holding portions 342 (hidden in FIG. 6). When the press rods 51 are pushed to extend into the clearances 343 of the holding portions 342 along the two opposite inward directions transverse to the guide pins 35, the clip arms 344 of each holding portion 342 are moved away from each other and disengage from the engagement groove 351 of the corresponding guide pin 35. The springs 52 respectively abut the press rods 51 and the lateral portions 421 to position and restore the press rods 51.

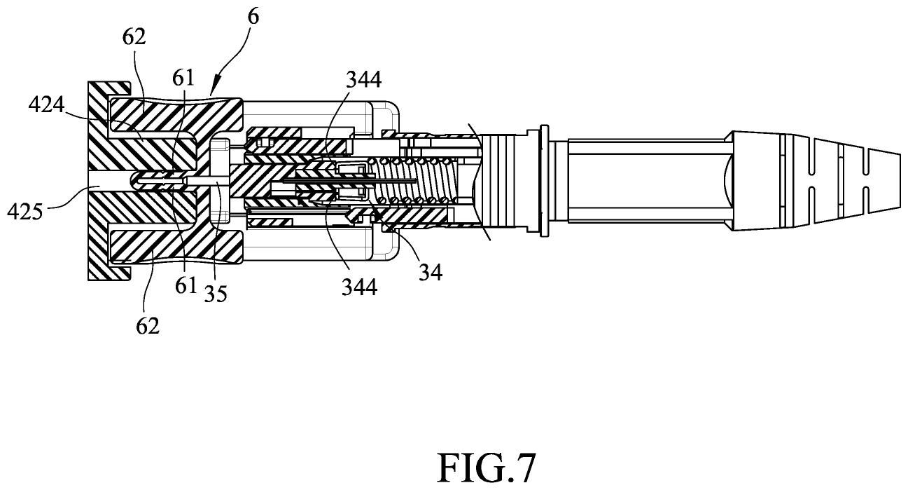

Referring to FIG. 7, in combination with FIGS. 3 and 6, the removal member 6 is made of a resilient material such as rubber or plastic, and is movably mounted to the outer housing 42 within the receiving space 43 forwardly of the inner sleeve member 41 at the front of the ferrule 33. In this embodiment, the removal member 6 is disposed between the lateral portions 421 and limited by the front wall portion 422 and the inner sleeve member 41 from moving forward and rearward further. In addition, the removal member 6 includes two clamping plates 61, two press portions 62 and a connection portion 63. The clamping plates 61 respectively lie above and below the guide pins 35. The press portions 62 are respectively connected to and disposed above and below the clamping plates 61. The connection portion 63 is connected between the clamping plates 61 and has a U-shaped cross section. The clamping plates 61 convergingly extend in a forward direction to the connection portion 63 and diverge in a rearward direction to respectively connect the press portions 62. Each press portions 62 has a press plate 621, and a stem 622 transversely projecting from the press plate 621 and connecting one of the clamping plates 61. The press plates 621 of the press portions 62 are disposed between the lateral portions 421 and respectively proximal to top and bottom sides of the lateral portions 421. The receiving space 43 is open at the top and bottom sides of the lateral portions 421 to expose the press plates 621, such that the press portions 62 are operable to press the clamping plates 61 toward each other for clamping both of the guide pins 35 and are movable relative to the housing unit 4 to pull and release the guide pins 35 from the pin retainer 34.

In use, the removal member 6 is first placed in the receiving space 43 of the outer housing 42. The connection portion 63 of the removal member 6 extends forwardly and slidably into the mounting hole 425 of the clamping plate mount 424 until the press portions 62 respectively abut against rear ends of the upper and lower abutment members 423. As shown in FIG. 6, the clamping plates 61 are in a non-clamping position. The outer housing 42 is snuggly sleeved around the inner sleeve 41 when the inner sleeve 41 is inserted into the retaining grooves 4212 and the receiving space 43 until resilient tabs 411 of the inner sleeve member 41 respectively engage slots 44 of the outer housing 42 (see FIGS. 3 and 5) and until the shoulder faces 4213 of the lateral portions 421 abut and limit the front end of the inner sleeve member 41 from moving forward and toward the removal member 6 (see FIGS. 6 and 7). The shoulder faces 4213 stops the inner sleeve member 41 at a particular position relative to the outer housing 42 so that two notches 46 of the outer housing 42 are respectively aligned with two notches 47 of the inner sleeve member 41. Afterwards, each press rod 51 with the spring 52 is inserted into one of the notches 46 of the outer housing 42 and one of the notches 47 of the inner sleeve member 41 such that each spring 52 is received in one of two spring-receiving space 48 of the outer housing 42, thereby completing assembly of the pin removal device 2.

To remove the guide pins 35 by the pin removal device 2, the fiber optic connector 3 is moved forward and inserted into the inner sleeve 41. The press rods 51 are first pressed to move toward the pin retainer 34 along the two opposite inward directions transverse to the guide pins 35. By virtue of the press rods 51 extending into the clearances 343 of the holding portions 342, the clip arms 344 of the holding portions 342 are moved away from each other and disengage from the respective guide pins 35. By pressing the press portions 62 of the removal member 6, the clamping plates 61 of the removal member 6 clamp the guide pins 35. As shown in FIG. 7, when the press portions 62 are pressed, the upper one of the press portions 62 is moved downward from the upper abutment member 423 and the lower one of the press portions 62 is moved upward from the lower abutment members 423 so that the removal member 6 is allowed to move forward. When the removal member 6 is moved forwardly relative to the housing unit 4, the U-shaped connection member 63 moves forward into the mounting hole 425, the clamping plates 61 move toward each other to clamp and pull the guide pins 35 from the pin retainer 34.

It is worth to mention that, when the pin removal device 2 is installed on the fiber optic connector 3, because the guide pins 35 automatically and directly extend in between the clamping plates 61, it is unnecessary for a user to register the removal member 6 with the guide pins 35. On the other hand, because the length of the receiving space 43 is sufficient for the removal member 6 to move forward and pull the guide pins 35 until the guide pins 35 are released from the pin retainer 34 (but are not released from the ferrule 33), the user needs not pull and move the guide pins 35 extra distance during application of forces, thereby saving labor energies. In addition, because the guide pins 35 are disposed at the rear of the removal member 6 and in between the lateral portions 421 of the housing unit 4, even if the guide pins 35 are released from the clamping plates 61 of the removal member 6, the guide pins 35 can be confined within the housing unit 4 and will not fly outward and become lost.

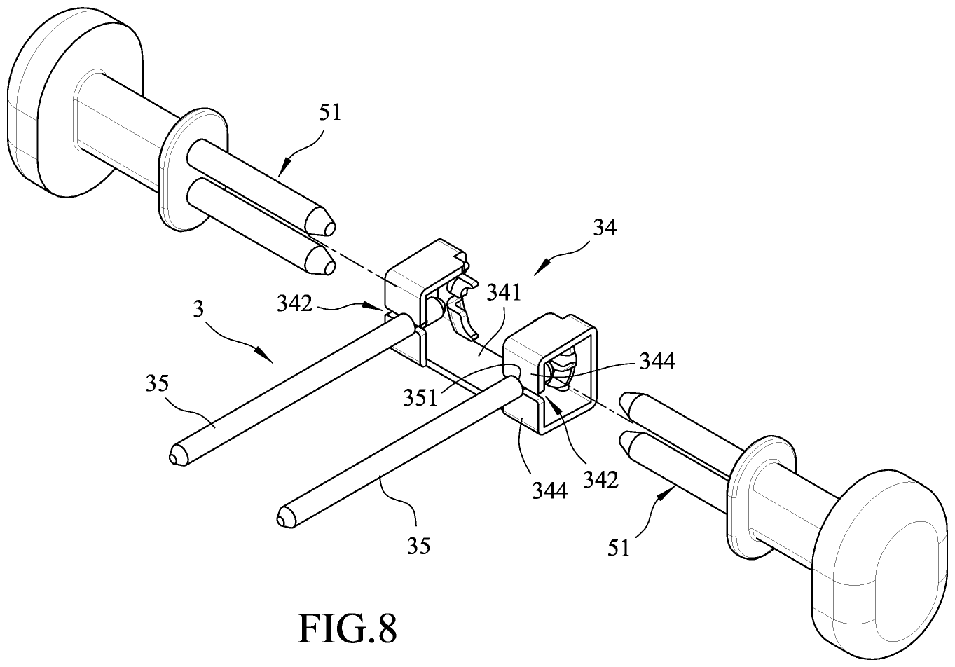

Referring to FIG. 8, each press rod 51 has a fork-like shape. When each press rod 51 is inserted into the respective holding portion 342, the clip arms 344 thereof are moved away from each other and disengaged from the engagement grooves 351 of the respective guide pin 35. However, the press rods 51 are not limited to this configuration.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A pin removal device for a fiber optic connector, which includes a casing sleeve surrounding a ferrule, guide pins protruding from a front face of the ferrule, and a pin retainer engaging the guide pins inside the casing sleeve for retention of the guide pins, the pin removal device comprising:
a housing unit configured to removably disposed around the casing sleeve, the front face of the ferrule and the guide pins, said housing unit including a receiving space configured to receive the guide pins and the front face of the ferrule;
a releasing unit configured to operate the pin retainer such that the pin retainer disengages from the guide pins, and insertable into said housing unit and the casing sleeve; and
a removal member movably inserted into said receiving space in front of the ferrule, said removal member being configured to clamp the guide pins and movable forwardly relative to said housing unit to pull the guide pins and release the same from the pin retainer when said releasing unit is inserted into said housing unit and the casing sleeve and operates the pin retainer to disengage from the guide pins.

2. The pin removal device as claimed in claim 1, wherein said removal member has two clamping plates configured to respectively lie above and below the guide pins, and two press portions respectively connected to and disposed above and below said clamping plates, said press portions being operable to press said clamping plates toward each other for clamping both of the guide pins and being movable relative to said housing unit to pull and release the guide pins from the pin retainer.

3. The pin removal device as claimed in claim 1, wherein said releasing unit includes two press rods, which are inserted into said housing unit respectively along two opposite inward directions transverse to the guide pins, and which are operable to respectively force the pin retainer to disengage from said guide pins.

4. The pin removal device as claimed in claim 2, wherein said removal member further has a connection portion connected between said clamping plates and having a U-shaped cross section.

5. The fiber optic assembly as claimed in claim 2, wherein said housing unit includes an inner sleeve member configured to sleeve around the casing sleeve rearwardly of said removal member, and an outer housing receiving said inner sleeve member and having said receiving space, said removal member being movably mounted to said outer housing within said receiving space forwardly of said inner sleeve member.

6. The pin removal device as claimed in claim 5, wherein said outer housing further includes a front wall portion and two spaced-apart lateral portions that extend rearwardly from said front wall portion and that define said receiving space therebetween, said removal member being disposed between said lateral portions and limited by said front wall portion and said inner sleeve member from moving forward and rearward.

7. The pin removal device as claimed in claim 6, wherein said outer housing further includes upper and lower abutment members respectively and rearwardly protruding from top and bottom ends of said front wall portion to abut said press portions.

8. The pin removal device as claimed in claim 7, wherein said outer housing further includes a clamping plate mount that protrudes rearwardly from said front wall portion and between said lateral portions and that has a mounting hole, said connection portion of said removal member extending forwardly and slidably into said mounting hole.

9. The pin removal device as claimed in claim 8, wherein said clamping plates convergingly extend in a forward direction to said connection portion and diverge in a rearward direction to respectively connect said press portions.

10. The pin removal device as claimed in claim 8, wherein each of said press portions has a press plate, and a stem transversely projecting from said press plate and connecting one of said clamping plates, said press plates of said press portions being disposed between said lateral portions and respectively proximal to top and bottom sides of said lateral portions, said receiving space being open at said top and bottom sides of said lateral portions to expose said press plates.

11. The pin removal device as claimed in claim 6, wherein said lateral portions respectively have inner surfaces that border said receiving space, and retaining grooves that are respectively indented from said inner surfaces proximal to rear ends of said lateral portions, said receiving space opening at said rear ends of said lateral portions, said inner sleeve member extending into said retaining grooves and said receiving space.

12. The pin removal device as claimed in claim 11, wherein each of said lateral portions further has a shoulder face bounding one of said retaining grooves, said shoulder faces of said lateral portions abutting and limiting said front end of said inner sleeve member from moving forward and toward said removal member.

13. The pin removal device as claimed in claim 6, wherein said press rods respectively extend through said lateral portions.

14. The pin removal device as claimed in claim 5, wherein said releasing unit further includes two springs that are respectively sleeved on said press rods, each of said springs abuts one of said press rods and said outer housing.

15. A combination comprising:
a fiber optic connector which includes a casing sleeve surrounding a ferrule, guide pins protruding from a front face of said ferrule, and a pin retainer engaging said guide pins inside said casing sleeve for retention of said guide pins; and
a pin removal device which includes
a housing unit removably disposed around said casing sleeve, said front face of said ferrule and said guide pins, said housing unit including a receiving space configured to receive said guide pins and said front face of said ferrule,
a releasing unit configured to operate said pin retainer such that said pin retainer disengages from said guide pins, said releasing unit being insertable into said housing unit and said casing sleeve, and
a removal member movably inserted into said receiving space in front of said ferrule, said removal member being configured to clamp said guide pins and movable forwardly relative to said housing unit to pull said guide pins and release the same from said pin retainer when said releasing unit is inserted into said housing unit and said casing sleeve and operates said pin retainer to disengage from said guide pins,
wherein said pin retainer has a bridge portion mounted to said casing sleeve, and two holding portions connected to said bridge portion and respectively holding said guide pins, each of said guide pins having an engagement groove engaging one of said holding portions.
